(19) United States
(12) Patent Application Publication
(10) Pub. No.: US 2004/0264334 A1
(43) Pub. Date: Dec. 30, 2004

(54) Digital recorder with amplifier

(76) Inventor: Yoshikazu Furuta, Nagoya (JP)

Correspondence Address: JOE NIEH, 18760 E. AMAR ROAD #204, WALNUT, CA, 91789, US

(21) Appl. No.: 10/610,263

(22) Filed: Jun. 30, 2003

(51) Int. Cl. G11B 19/00

(52) U.S. Cl. 369/59.15; 369/47.25

(57) ABSTRACT

A single-unit digital recorder with a built-in amplifier is disclosed. The digital recorder and the amplifier are both enclosed within the same housing and in electrical connection with each other for operation by a common set of controls. This design minimizes the weight of the components and also simplifies the controls for the components. The user only has to transport a fully integrated unit for both recording and amplifying functions.

### BACKGROUND

1. Field of Invention

The present invention relates generally to a recorder with a built-in amplifier. More specifically, the present invention is a digital recorder with a built-in amplifier.

2. Description of Related Art

A recorder is an electronic device used to record sounds such as music and human voice. The recorder may use removable medias such as audio cassette tapes to store the recordings. The recorder may also use non-removable means such as electronic digital memory to store the recordings. Many recorders also have the capability to play back the sounds that they recorded. An amplifier is an electronic device used to amplify an electrical signal from sources such as a guitar, electronic piano, or a microphone and outputs the amplified signal to another device such as a speaker. Generally an amplifier is a relatively large and heavy piece of electronic equipment.

Currently, separate components are used to record and amplify the sound. For example, an electronic guitar player will use an amplifier to amplify the signal from the electronic guitar to be reproduced by a large speaker to an audience. The electronic guitar player will have to use a separate recorder to record the sounds from the electronic guitar player when he is either practicing or performing for an audience so that the sounds may be recorded and preserved for future listening.

However, in the example above, the electronic guitar player will have to transport two separate relatively heavy and delicate components, both with their own case and redundant components, when he wish to amplify and record the sounds during his practice or performance to an audience. The two separate components occupy large amount of space and are relatively heavy due to their redundant heavy case. Furthermore, redundant controls such as power and other adjustments are required for each component.

### SUMMARY OF THE INVENTION

The present invention is a one-unit digital recorder with a built-in amplifier. The digital recorder and the amplifier are both enclosed within the same housing and in electrical connection with each other for operation by a common set of controls. This design minimizes the weight of the components and also simplifies the controls for the components. The user only has to transport a fully integrated unit for both recording and amplifying functions.

### BRIEF DESCRIPTION OF THE DRAWINGS

FIG. 1 shows the electronic schematics for the digital recorder with amplifier.

### DETAILED DESCRIPTION OF THE PREFERRED EMBODIMENT

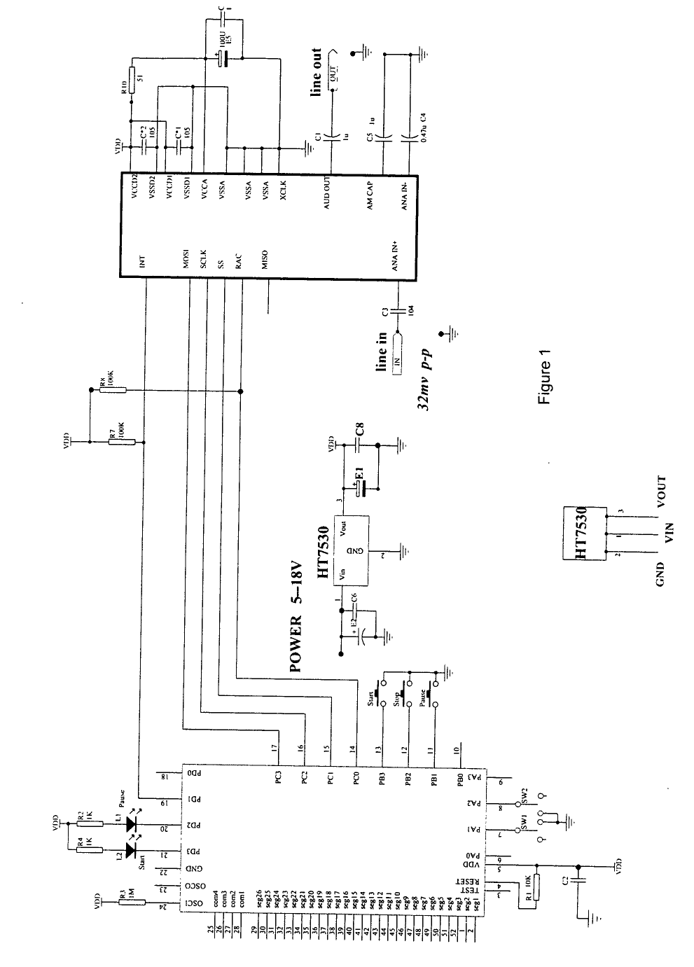

FIG. 1 shows the electronic schematics for the current preferred embodiment of the digital recorder with amplifier. A digital recorder is electrically connected to an amplifier and are both controlled by a common set of controls on the housing within which both the digital recorder and the amplifier are affixed. The controls comprise of buttons and/or switches for power, start, stop, pause, play, and record. The digital recorder may be used to record the electronic signals inputted and also to playback the recorded electronic signals in the form of audible sound through the built-in amplifier to one or more speakers. The amplifiers may also be used to directly amplify the electronic signals inputted and outputs the electronic signals to a speaker for amplified sound reproduction.

The entire integrated unit is much lighter than the conventional designs of two separate components. Furthermore, the redundant controls for both the digital recorder and the amplifier are eliminated and the resulting controls are simpler and easier to learn. The reduced complexity of the controls also has the benefit of reduced weight of the integrated unit. In addition, the digital recorder with amplifier allows the user to receive immediate feedback through the capability of the digital recorder with amplifier to record and playback the signals the user inputs into the integrated unit. Thus a user such as a guitar player will be able to immediately listen to the music that he played during practice to improve or modify it.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

What is claimed is:

1. A digital recorder with amplifier comprising:
a housing with controls;
a recorder affixed within said housing and controlled by the controls on the housing; and
an amplifier affixed within said housing and electrically connected to said recorder within said housing and also controlled by the controls on said housing;
wherein the recorder and amplifier form an integrated unit that can be controlled by the common set of controls on the housing.

2. A digital recorder with amplifiers as in claim 1, wherein the recorder is a digital recorder.

3. A digital recorder with amplifier as in claim 1, wherein the recorder is an audio cassette tape recorder.

4. A digital recorder with amplifier as in claim 1, wherein the recorder is a compact disc recorder.

5. A digital recorder with amplifier as in claim 1, wherein the recorder is a DVD recorder.
